(19) United States
(12) Patent Application Publication
(10) Pub. No.: US 2004/0004655 A1
(43) Pub. Date: Jan. 8, 2004

(54) Writing head and image forming apparatus using the same

(75) Inventors: Shinichi Kamoshida, Nagano-ken (JP); Atsunori Kitazawa, Nagano-ken (JP); Kenjiro Yoshioka, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/402,242

(22) Filed: Mar. 31, 2003

(30) Foreign Application Priority Data
Mar. 29, 2002 (JP) 2002-094899
Mar. 29, 2002 (JP) 2002-094903

(51) Int. Cl. B41J 2/39; G03G 15/01

(52) U.S. Cl. 347/117; 347/141

(57) ABSTRACT

In order to obtain image with high resolution and eliminate the nonuniformity of written latent images and toner images by achieving the formation of electrostatic latent images corresponding to the widths of driven writing electrodes, a writing head 3 has a plurality of writing electrodes 3b which are arranged along the axial direction of an image carrier 2 such that the writing electrodes 3b are in contact with the image carrier, wherein the writing electrodes 3b are aligned in the axial direction Y and the circumferential direction X of the image carrier 2 such that the writing electrodes 3b which are most adjacent to each other in the axial direction Y are not overlapped with each other as seen in the circumferential direction of the image carrier. (FIG. 12)

### BACKGROUND OF THE INVENTION

The present invention relates to an image forming apparatus in which an electrostatic latent image is formed on an image carrier by writing electrodes of a writing head, thereby forming an image.

In conventional image forming apparatus, such as copying machines and printers utilizing electrophotographic technology, an electrostatic latent image is formed commonly by uniformly charging the surface of a photoreceptor and exposing the uniformly charged surface of the photoreceptor to light from an exposure device such as laser light or LED lamp light. Then, the electrostatic latent image on the surface of the photoreceptor is developed by a developing device to form a toner image on the photoreceptor and the toner image is transferred to a recording medium such as a paper by a transferring device, thereby forming an image.

In such a conventional image forming apparatus as mentioned above, the exposure device as a writing device for forming an electrostatic latent image is composed of a device of generating leaser beams or LED lamp light so that the image forming apparatus must have large size and complex structure.

For this reason, an image forming apparatus in which an electrostatic latent image is written on a surface of an image carrier by writing electrodes without using laser light nor LED lamp light has been proposed in Japanese Patent Unexamined Publication No. 2001-287396. In addition, this applicant filed an application for a patent as Japanese Patent Application No. 2001-227630.

FIG. 1 is an illustration schematically showing the basic structure of an image forming apparatus according to Japanese Patent Application No. 2001-227630 as a prior application. The image forming apparatus 1 comprises an image carrier 2 having a substrate 2a which is made of a conductive material and is grounded and a chargeable layer 2b which is formed on the outer periphery of the substrate 2a and has an insulating property and on which a electrostatic latent image is formed, a writing head 3 having a flexible substrate 3a, having high insulation property and being relatively soft and elastic and writing electrodes 3b which are supported by the substrate 3a and are pressed lightly against the image carrier 2 with weak elastic restoring force created by deflection of the substrate 3a so that the writing electrodes 3b are in plane contact with the chargeable layer 2b of the image carrier 2 to write the electrostatic latent image on the chargeable layer 2b, a developing device 4 having a development roller 4a as a developer carrier, and a transferring device 6 having a transfer roller 6a as a transfer member.

In the image forming apparatus 1 having a structure as mentioned above, after the chargeable layer 2b of the image carrier 2 is made into the uniformly charged state, writing voltage is applied to the writing electrodes 3b via IC drivers 11, and an electrostatic latent image is written on the uniformly charged image carrier 2 mainly via the charge transfer (for example, charge injection) between image carrier 2 and the writing electrodes 3b of the writing head 3 which are in plane contact with each other. That is, the electrostatic latent image is written on the chargeable layer 2b of the image carrier 2. The electrostatic latent image on the chargeable layer 2b of the image carrier 2 is then developed with developer carried by the development roller 4a of the developing device 4 to form a developer image and the developer image is transferred to the recording medium 5 such as a paper by the transfer roller 6a to which transfer voltage is applied.

FIG. 2 shows an example of the writing head 3 in FIG. 1. A plurality of writing electrodes 3b1 through 3b5 are aligned in two rows extending in the axial direction of the image carrier 2, one of the two rows being composed of the electrodes 3b1, 3b3, 3b5 and the other row being composed of the electrodes 3b2 and 3b4, in such a manner that the writing electrodes 3b1, 3b3, 3b5 and 3b2, 3b4 which are in different rows are partially overlapped with each other as seen in the direction perpendicular to the axial direction Y of the image carrier 2 (the circumferential direction of the image carrier 2). In case that writing electrodes 3b are aligned simply in one row in the axial direction Y of the image carrier 2, crosstalk (leakage of electric current) occurs between the writing electrodes 3b if the distance L between adjacent writing electrodes 3b is too small. Therefore, it is required to ensure some degree of distance L between adjacent writing electrodes 3b. As a result of this, it is impossible to obtain images of high resolution. This is the reason of the aforementioned arrangement. Among the writing electrodes, a predetermined number (five, in the illustrated example) of writing electrodes are connected to one driver 11 which controls the ON/OFF of the writing electrodes by switching the voltage to a predetermined voltage or ground voltage so that the writing electrodes are united as one set. Plural sets of writing electrodes are aligned in a row extending in the axial direction Y of the image carrier 2.

The right side of FIG. 2 shows patterns 1 through 3 of electrostatic latent images which are formed according to ON and OFF of the writing electrodes 3bl through 3b5 by rotating the image carrier 2 in the direction of arrow X. The pattern 1 is a case that all of the writing electrodes 3b1 through 3b5 are ON so as to form electrostatic latent images corresponding to the widths in the direction of arrow Y of the writing electrodes 3b1 through 3b5. The pattern 2 is a case that the writing electrodes 3b1, 3b3, 3b5 are ON and the writing electrodes 3b2, 3b4 are OFF so as to form electrostatic latent images corresponding to the widths in the direction of arrow Y of the writing electrodes 3b1, 3b3, and 3b5.

However, there is a problem that when the writing electrodes 3b2, 3b4 are ON and the writing electrodes 3b1, 3b3, 3b5 are OFF just like the pattern 3, an electrostatic latent image of the width Y1 in the direction of arrow Y of each writing electrode 3b2, 3b4 is narrowed to the width Y2 between the writing electrodes 3b1 and 3b3 or 3b3 and 3b5 because the writing electrodes 3b2, 3b4 are partially overlapped with the writing electrodes 3b1, 3b3, 3b5 so that parts are eliminated by the writing electrodes 3b1, 3b3, 3b5 located on the downstream side.

There is also a problem that charge injected from the writing electrodes 3b into the chargeable layer 2b is easily leaked within the chargeable layer 2b. For this, as shown in FIG. 4, the chargeable layer 2b may be composed of a dielectric layer 2c and an independent-floating-electrode layer 2d having a large number of independent electrodes 2d₁ exposed on the surface of the dielectric layer 2c. In this case, when writing an image, for example, positive (+) writing voltage is applied from the writing electrodes 3b to the independent electrodes 2d₁ so as to conduct image writing. A predetermined charge can be held during a period from time just after the image writing by the writing voltage to the independent electrodes 2d₁ to time for development, thereby developing the electrostatic latent image by the developing device.

At a contact portion (nip portion) between the writing electrodes 3b and the image carrier 2, an electric equivalent circuit as shown in FIG. 6(b) is constituted. That is, a serial circuit of resistance R of the writing electrodes 3b and the independent electrodes 2d₁ (including contact resistance therebetween) and the capacity C of the dielectric layer 2c is connected to a power source through a switch S. The resistance R is selectively switched to be connected to the A side of a predetermined negative (−) voltage V0 or to the B side of the ground voltage V₁. Accordingly, by selectively applying voltage to the writing electrodes 3b, an electrostatic latent image is written.

For example, when writing pulse of rectangular wave, as shown in FIG. 15(A), is applied to the writing electrode 3b into the serial CR circuit as shown in FIG. 6(b), an electrostatic latent image produced on the image carrier 2 shows delays at pulse rise portion and pulse fall portion due to the damping time constant (τ=CR) as shown in FIG. 15(B). The production instability due to the delays should be significant as the capacity C of the dielectric layer 2c of the image carrier 2 is larger or as the resistance R of the writing electrodes 3b and the independent electrodes 2d₁ (including contact resistance therebetween) is larger.

### SUMMARY OF THE INVENTION

The present invention was made to overcome the aforementioned problems of conventional techniques. The first object of the present invention is to provide a writing head which can form electrostatic latent images corresponding to the widths of driven writing electrodes, thereby obtaining image with high resolution and eliminating the nonuniformity of written latent images and toner images and to provide an image forming apparatus having the writing head.

To achieve the aforementioned object, a writing head of the present invention is a writing head having a plurality of writing electrodes which are arranged along the axial direction of an image carrier such that the writing electrodes are in contact with the image carrier, and is characterized in that the writing electrodes are aligned in the axial direction and the circumferential direction of the image carrier such that the writing electrodes which are most adjacent to each other in the axial direction are not overlapped with each other as seen in the circumferential direction of the image carrier.

The second object of the present invention is to provide an image forming apparatus in which an electrostatic latent image on an image carrier is formed by writing electrodes and which can provide improved contrast in the electrostatic latent image and improved reproducibility of the electrostatic latent image.

To achieve the aforementioned object, an image forming apparatus of the present invention is an image forming apparatus comprising at least an image carrier having a chargeable layer, a writing head having a plurality of writing electrodes arranged in the axial direction of said image carrier, and a developing device for developing an electrostatic latent image written by said writing electrodes, and is characterized in that the writing pulse to be applied to said writing electrodes is controlled such that a value of applied voltage at the rise portion is set to be higher than the mean value of applied voltage.

### BRIEF DESCRIPTION OF THE DRAWINGS

FIG. 1 is an illustration schematically showing the basic structure of an image forming apparatus according to Japanese Patent Application No. 2001-227630 as a prior application;

FIG. 2 is an illustration for explaining the problem to be solved by the present invention;

FIGS. 3(A), 3(B) shows an example of an image forming apparatus according to the present invention, wherein FIG. 3(A) is an illustration showing the entire structure and FIG. 3(B) is a partial perspective view of an image carrier and a chargeable writing device;

FIG. 4 is an enlarged view partially and schematically showing the image carrier shown in FIGS. 3(A), 3(B);

FIGS. 5(A)-5(D) are illustrations each showing an example of the basic process of forming an image in the image forming apparatus of the present invention;

FIGS. 6(a)-6(f) are illustrations for explaining the principle of writing an electrostatic latent image by writing electrodes of a writing device through application or removal of charge;

FIGS. 7(a)-7(c) are illustrations for explaining the application or removal of charge relative to the image carrier;

FIG. 8 is a diagram showing a switching circuit for switching the voltage to be supplied to the writing electrodes between the predetermined voltage V₀ and the ground voltage V₁;

FIGS. 9(a)-9(c) are illustrations showing profiles when the supply voltage for each electrode is selectively controlled into the predetermined voltage V₀ or the ground voltage V₁ by switching operation of the corresponding high voltage switch;

FIG. 10 is a plan view schematically showing one embodiment of the writing head of the present invention;

FIGS. 11(A), 11(B) are plan views showing examples of allay patterns of the writing electrodes shown in FIG. 10;

FIG. 12 is an illustration for explaining the work of the present invention;

FIGS. 13(A)-13(C) are plan views schematically showing other embodiments of the writing head of the present invention;

FIG. 14 is a plan view schematically showing another embodiment of the writing head of the present invention;

FIGS. 15(A), 15(B) are illustrations for explaining the problem to be solved by the present invention;

FIGS. 16(A), 16(B) show an embodiment of the image forming apparatus according to the present invention, wherein FIG. 16(A) is a wave form chart showing outputs to writing electrodes and FIG. 16(B) is a wave form chart showing voltages at independent electrodes;

FIGS. 17(A), 17(B) are illustrations showing another embodiment of the image forming apparatus according to the present invention;

FIGS. 18(A), 18(B) are illustrations showing another embodiment of the image forming apparatus according to the present invention;

FIGS. 19(A), 19(B) are illustrations showing another embodiment of the image forming apparatus according to the present invention;

FIGS. 20(A), 20(B) are illustrations showing another embodiment of the image forming apparatus according to the present invention;

FIGS. 21(A), 21(B) are illustrations showing another embodiment of the image forming apparatus according to the present invention;

FIGS. 22(a), 22(b) are illustration schematically showing different examples of the image forming apparatus using the writing head of the present invention;

FIG. 23 is an illustration schematically showing another example of the image forming apparatus using the writing head of the present invention;

FIG. 24 is an illustration schematically showing another example of the image forming apparatus using the writing head of the present invention; and

FIG. 25 is an illustration schematically showing another example of the image forming apparatus using the writing head of the present invention.

### DETAILED DESCRIPTION OF THE PREFERRED EMBODIMENTS

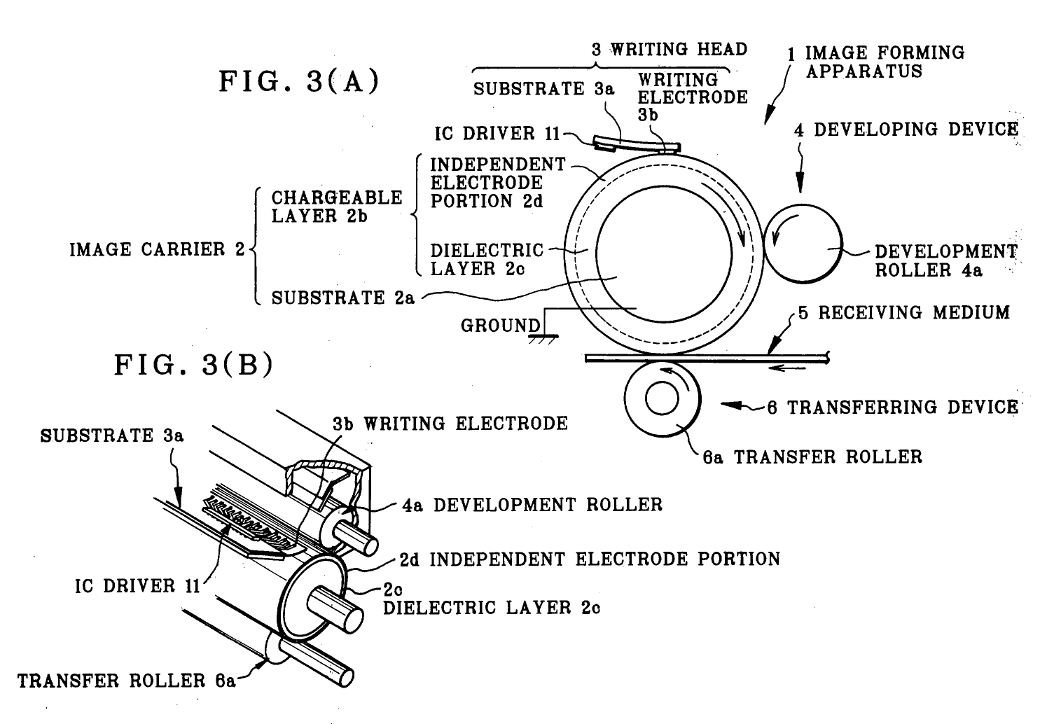

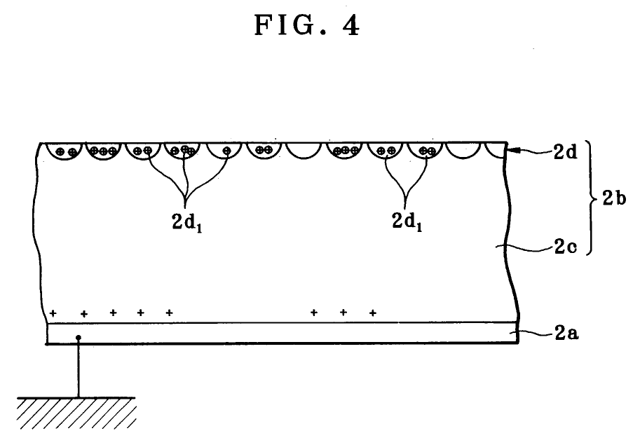

Hereinafter, embodiments of the present invention will be described with reference to the drawings. FIGS. 3(A), 3(B) show an embodiment of an image forming apparatus according to the present invention, wherein FIG. 3(A) is an illustration showing the basic structure and FIG. 3(B) is a perspective view showing specific structure of FIG. 3(A). FIG. 4 is an enlarged view partially and schematically showing the image carrier shown in FIGS. 3(A), 3(B).

As shown in FIGS. 3(A), 3(B), an image forming apparatus 1 comprises at least an image carrier 2 having a substrate 2a which is made of a conductive material such as aluminum and is grounded and a chargeable layer 2d which is formed on the outer periphery of the substrate 2a and has an insulating property and on which a electrostatic latent image is formed, a writing head 3 having a flexible substrate 3a, having high insulation property and being relatively soft and elastic, such as a FPC (Flexible Print Circuit) or a PET (polyethylene terephthalate), and writing electrodes 3b which are supported by the substrate 3a and are pressed lightly against the image carrier 2 with weak elastic restoring force created by deflection of the substrate 3a so that the writing electrodes 3b are in plane contact with the chargeable layer 2b of the image carrier 2 to write the electrostatic latent image on the chargeable layer 2b, a developing device 4 having a development roller 4a as a developer carrier, and a transferring device 6 having a transfer roller 6a as a transfer member.

The chargeable layer 2b is composed of a dielectric layer 2c as an insulating layer and an independent electrode portion 2d as an image writing portion provided on the surface of the dielectric layer 2c. As shown in FIG. 4, the independent electrode portion 2d comprises a large number of independent floating electrodes (hereinafter, sometimes called just “independent electrodes”) 2d₁ provided on the outer surface of the dielectric layer 2c. These independent electrodes 2d₁ are electrically independent of each other and are formed in the islands-in-sea structure exposed on the outer surface of the dielectric layer 2b. Though the dielectric layer 2c and the independent electrode portion 2d are zoned from each other in FIG. 4, this is only for the sake of simplicity of the explanation. The dielectric layer 2c and the independent electrode portion 2d are not clearly zoned from each other. A portion where a large number of independent electrodes 2d₁ exist of the outer layer of the dielectric layer 2c is the independent electrode portion 2d.

For forming image, for example, positive (+) voltage applied to the writing electrodes 3b via IC drivers 11 is applied as the writing voltage V₁ from the writing electrodes 3b to the independent electrode portion 2d. Accordingly, positive charge is applied to image writing portions of the independent electrode portion 2d so as to write an image on the independent electrode portion 2d.

Examples of the material for the dielectric layer 2c are polyester resin, polycarbonate resin, acrylate resin, polystyrene resin, Polyarylate, polysulfone, polyphenylene oxide, vinyl chloride resin, polyurethane resin, epoxy resin, silicone resin, alkyd resin, phenolic resin, polyamide resin, and vinyl chloride-vinyl acetate copolymer resin. These may be used alone or may be used, as a polymer alloy, in combination with one or more among the others.

In the independent electrode portion 2d, a large number of independent electrodes 2d₁ are formed by coating the outer layer of the dielectric layer 2c with material which is prepared by mixing the same resin and a large number of conductive fine particles to have a regulated mixing ratio (concentration) and dispersing (dilute and disperse) the mixture into solvent. The coating method may be an ordinal suitable method such as a spray coating method, dip coating method, and the like. In this case, the independent electrodes 2d₁ are exposed on the outer surface. Alternatively, the independent electrodes 2d₁ may be ground to be exposed on the outer surface. In this case, the surface smoothness is improved, thus reducing the contact resistance between the independent electrodes 2d₁ and the writing electrodes 3b and reducing the abrasion between the writing head 3 and the chargeable layer 2b.

Examples of the material of conductive fine particles are:

(1) metallic fine particles such as Cu, Al, Ni, Ag, C, or Mo,

(2) fine particles such as ZnO (zinc oxide), tin oxide, antimony oxide, or titanium oxide subjected by a conductivizing process (for example, doped with antimony, indium); and

(3) conductive fine particles such as polyacetylene, polythiophene, or polypirrole doped with iodine to be polymer complex.

In the image forming apparatus 1 having a structure as mentioned above, after the chargeable layer 2b of the image carrier 2 is made into the uniformly charged state, writing voltage is applied to the writing electrodes 3b via IC drivers 11 for the writing electrodes 3b, and an electrostatic latent image is written on the uniformly charged image carrier 2 mainly via the charge transfer (for example, charge injection) between image carrier 2 and the writing electrodes 3b of the writing head 3 which are in plane contact with each other. That is, the electrostatic latent image is written on the chargeable layer 2b of the image carrier 2. The electrostatic latent image on the chargeable layer 2b of the image carrier 2 is then developed with developer carried by the development roller 4a of the developing device 4 to form a developer image and the developer image is transferred to the recording medium 5 such as a paper by the transfer roller 6a to which transfer voltage is applied.

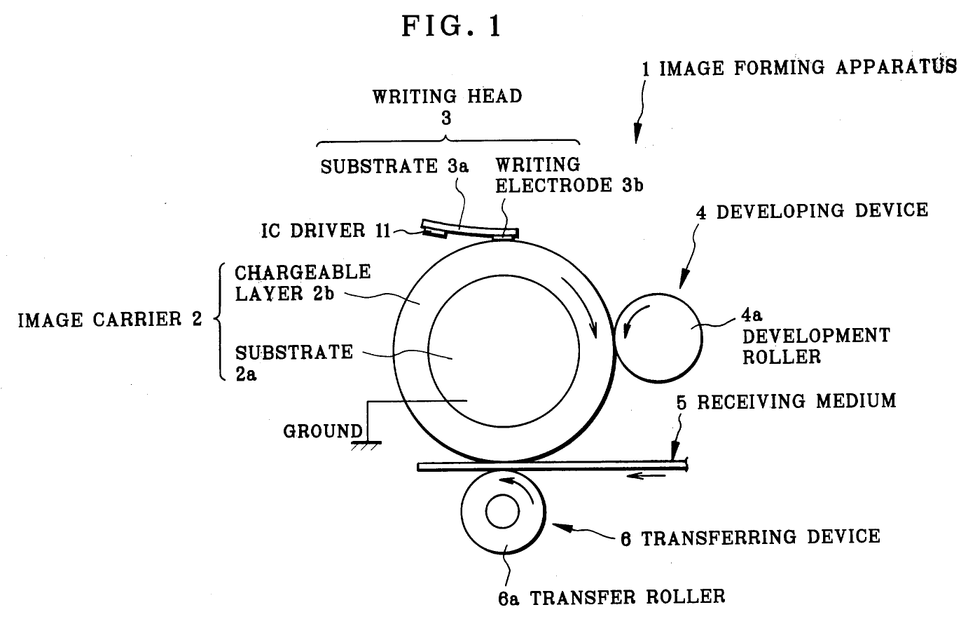

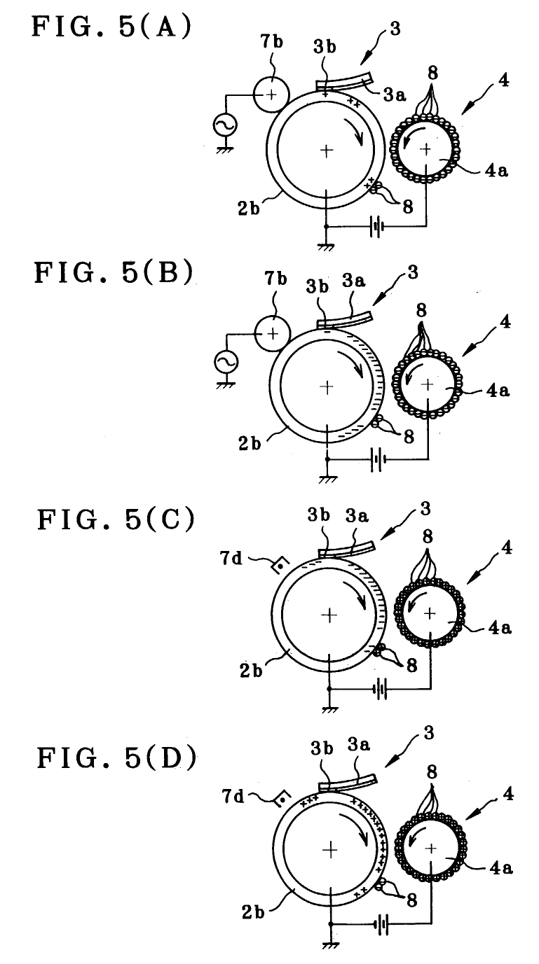

FIGS. 5(A)-5(D) are views each illustrating an example of the basic process of forming an image in the image forming apparatus 1 of FIG. 1. As the basic process of forming an image in the image forming apparatus 1 of the present invention, there are four types as follows: (1) making uniformly charged state by removal of charge-writing by contact application of charge-normal development; (2) making uniformly charged state by removal of charge-writing by contact application of charge-reversal development; (3) making uniformly charged state by application of charge-writing by contact removal of charge-normal development; and (4) making uniformly charged state by application of charge-writing by contact removal of charge-reversal development.

(1) making uniformly charged state by removal of charge-writing by contact application of charge-normal development

A process illustrated in FIG. 5(A) is an example of this image forming process. As shown in FIG. 5(A), in this example, a chargeable layer 2b is employed as the image carrier 2 and a charge removing roller 7b is employed as the charge control device 7. The charge removing roller 7b removes charge from the chargeable layer 2b to make the surface into the uniformly charged state with nearly 0V (zero volt). The image portions of the chargeable layer 2b are positively (+) charged by the writing electrodes 3b of the writing head 3 which are in contact with the chargeable layer 2b, thereby writing an electrostatic latent image onto the chargeable layer 2b. Similarly to conventional ones, a bias voltage composed of a direct current of a negative (−) polarity may be applied to the development roller 4a of the developing device 4. It should be noted that a bias voltage composed of an alternating current superimposed on a direct current of a negative (−) polarity may be applied to the development roller 4a. On the other hand, a bias voltage composed of an alternating current is applied to the charge removing roller 7b.

(2) making uniformly charged state by removal of charge-writing by contact application of charge-reversal development

A process shown in FIG. 5(B) is an example of this image forming process. As shown in FIG. 5(B), in this example, a chargeable layer 2b is employed as the image carrier 2 and a charge removing roller 7b is employed as the charge control device 7 just like the example shown in FIG. 5(A). The writing electrodes 3b of the writing head 3 are arranged in contact with the chargeable layer 2b to negatively (−) charge non-image portions of the chargeable layer 2b. Other structures of this example are the same as those of the aforementioned example shown in FIG. 5(A).

In the image forming process of this example, the charge removing roller 7b is in contact with the chargeable layer 2b so as to remove charge from the surface of the chargeable layer 2b to make the surface into the uniformly charged state with nearly 0V (zero volt). The image forming actions after that are the same as those of the aforementioned example shown in FIG. 5(A).

(3) making uniformly charged state by application of charge-writing by contact removal of charge-normal development

A process shown in FIG. 5(C) is an example of this image forming process. As shown in FIG. 5(C), in this example, a chargeable layer 2b is employed as the image carrier 2 and a corona discharging device 7d is employed as the charge control device 7. A bias voltage composed of a direct current of a negative (−) polarity or a bias voltage composed of an alternating current superimposed on a direct current of a negative (−) polarity is applied to the corona discharging device 7d, but not illustrated. The writing electrodes 3b of the writing head 3 are arranged in contact with the chargeable layer 2b to remove negative (−) charge from the non-image portions of the chargeable layer 2b. Moreover, a bias voltage composed of a direct current of a positive (+) polarity is applied to the development roller 4a so that the development roller 4a conveys positively (+) charged developer 8 to the chargeable layer 2b.

In the image forming process of this example, the surface of the chargeable layer 2b is negatively (−) charged by the corona discharging device 7d to make the surface of the chargeable layer 2b into the uniformly charged state with the predetermined voltage and, after that, negative (−) charge is removed from the non-image portions of the chargeable layer 2b by the writing electrodes 3b of the writing head 3, thereby writing an electrostatic latent image on the chargeable layer 2b. Then, positively (+) charged developer 8 conveyed by the development roller 4a of the developing device 4 adheres to the image portions, negatively (−) charged, of the chargeable layer 2b, thereby normally developing the electrostatic latent image.

(4) making uniformly charged state by application of charge-writing by contact removal of charge-reversal development

A process shown in FIG. 5(D) is an example of this image forming process. In this example, a chargeable layer 2b is employed as the image carrier 2 and a corona discharging device 7d is employed as the charge control device 7. Similarly to the conventional one, a bias voltage composed of a direct current of a positive (+) polarity or a bias voltage composed of an alternating current superimposed on a direct current of a positive (+) polarity is applied to the corona discharging device 7d, but not illustrated.

In the image forming process of this example, the surface of the chargeable layer 2b is positively (+) charged by the corona discharging device 7d to make the surface of the chargeable layer 2b into the uniformly charged state with the predetermined voltage and, after that, positive (+) charge is removed from the image portions of the chargeable layer 2b by the writing electrodes 3b of the writing head 3, thereby writing an electrostatic latent image onto the chargeable layer 2b. Then, positively (+) charged developer 8 conveyed by the development roller 4a of the developing device 4 adheres to the image portions, not positively (+) charged, of the chargeable layer 2b, thereby reversely developing the electrostatic latent image.

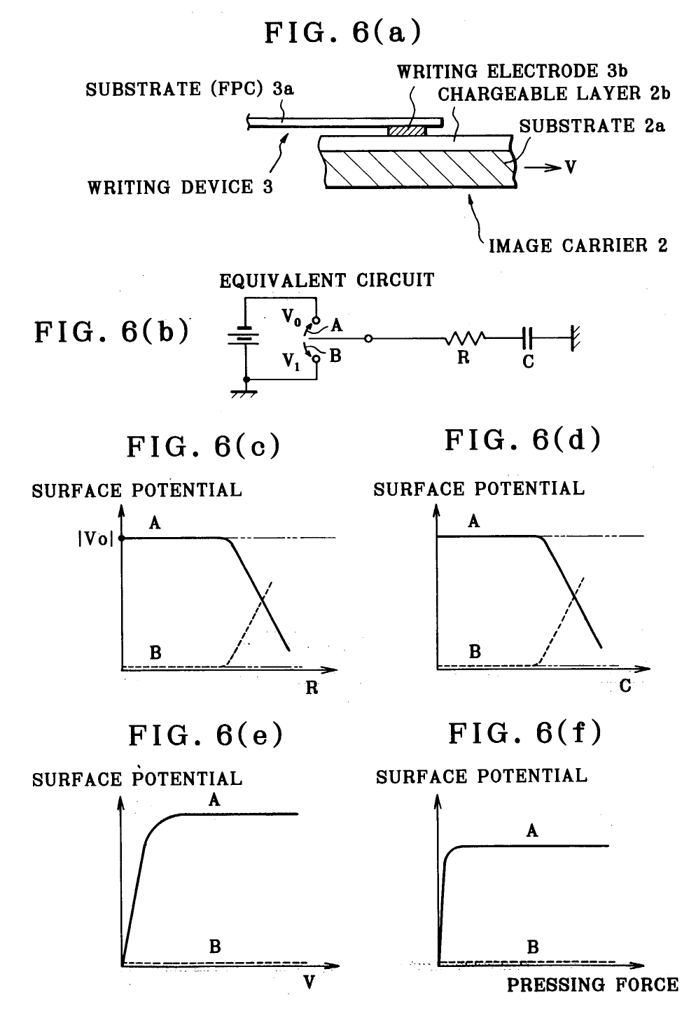

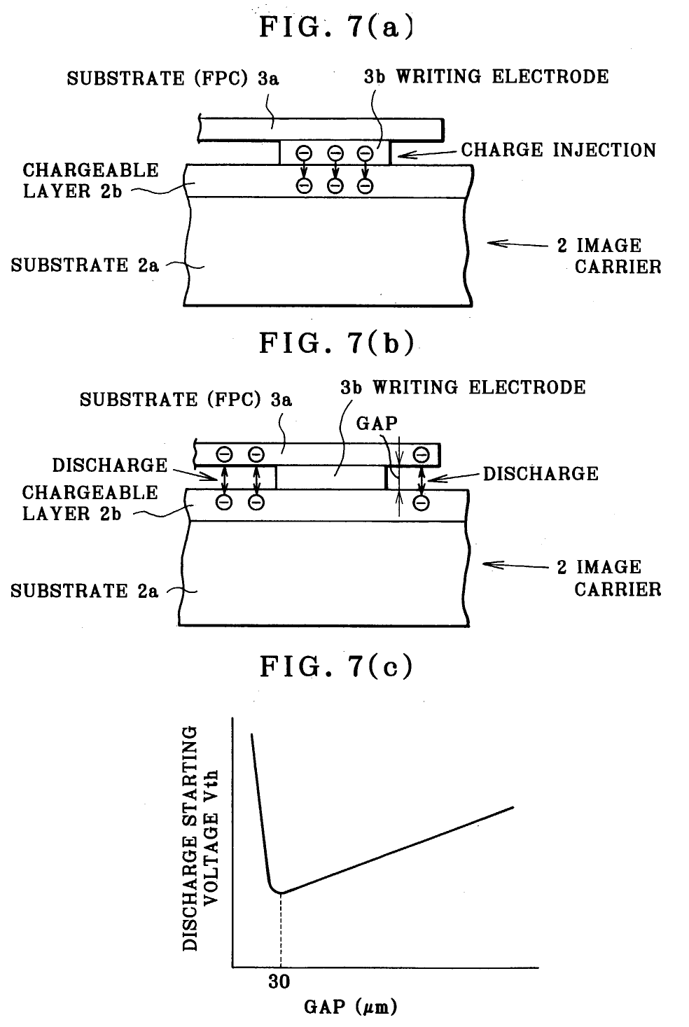

FIGS. 6(a)-6(f) are views for explaining the principle of writing an electrostatic latent image by the writing electrodes 3b of the writing device 3 through application or removal of charge, wherein FIG. 6(a) is an enlarged view of a contact portion between a writing electrode 3b and the image carrier 2, FIG. 6(b) is a diagram of an electrical equivalent circuit of the contact portion, and FIGS. 6(c)-6(f) are graphs each showing the relation between each parameter and the surface potential of the image carrier 2. FIGS. 7(a)-7(c) are views for explaining the application or removal of charge relative to the image carrier, wherein FIG. 7(a) is a view for explaining the application or removal of charge relative to the image carrier via the charge injection, FIG. 7(b) is a view for explaining the application or removal of charge relative to the image carrier via the discharge, and FIG. 7 (c) is a graph for explaining Paschen's law.

As shown in FIG. 6(a), the image carrier 2 comprises a substrate 2a which is made of a conductive material such as aluminum and is grounded and an insulating chargeable layer 2b formed on the outer periphery of the substrate 2a. The writing electrodes 3b supported by the substrate 3a made of FPC or the like of the writing device 3 are in contact with the chargeable layer 2b with a predetermined small pressing force and the image carrier 2 travels (rotates) at a predetermined speed “v”. As the aforementioned small pressing force, 10N or less per 300 mm in width, that is, a linear load of 0.03 N/mm or less is preferable for stabilizing the contact between the writing electrodes 3b and the image carrier 2 and for stabilizing the charge injection or discharge therebetween. In view of abrasion, it is preferable to achieve the smallest possible linear load while keeping the contact stability.

Either of a predetermined high voltage V₀ and a predetermined low voltage V₁ is selectively impressed to the writing electrodes 3b through the substrate 3a (as mentioned, since there are positive and negative charges, the high voltage is a voltage having a high absolute value and the low voltage is a voltage of the same polarity as the high voltage and having a low absolute value or 0V (zero volt). In the description of the present invention in this specification, the low voltage is a ground voltage. In the following description, therefore, the high voltage V₀ is referred to as the predetermined voltage V₀ and the low voltage V₁ is referred to as the ground voltage V₁. It should be understood that the ground voltage V₁ is 0V (zero volt).)

That is, the contact portion (nip portion) between each writing electrode 3b and the image carrier 2 is provided with an electrical equivalent circuit as shown in FIG. 6(b). In FIG. 6(b), “R” designates the resistance of the writing electrode 3b and “C” designates the capacity of the image carrier 2. The resistance R of the writing electrode 3b is selectively switched to be connected to the A side of the predetermined voltage V₀ of a negative (−) polarity or to the B side of the ground voltage V₁.

FIG. 6(c) shows the relation between the resistance R of the writing electrode 3b and the surface potential of the image carrier 2. The aforementioned relation when the writing electrode 3b is connected to the A side in the electrical equivalent circuit to impress the predetermined voltage V₀ of a negative (−) polarity to the writing electrode 3b is represented by a solid line in FIG. 6(c). As shown by the solid line in FIG. 6(c), the surface potential of the image carrier 2 is constant at the predetermined voltage V₀ in a region where the resistance R of the writing electrode 3b is small, and the absolute value of the surface potential of the image carrier 2 decreases in a region where the resistance R of the writing electrode 3b is greater than a predetermined value. On the other hand the relation between the resistance R of the writing electrode 3b and the surface potential of the image carrier 2 when the writing electrode 3b is connected to the B side to ground the electrode 3b is represented by a dotted line in FIG. 6(c). As shown by the dotted line in FIG. 6(c), the surface potential of the image carrier 2 is constant at substantially the ground voltage V₁ in a region where the resistance R of the writing electrode 3b is small, and the absolute value of the surface potential of the image carrier 2 increases in a region where the resistance R of the writing electrode 3b is greater than the predetermined value.

In the region where the resistance R of the writing electrode 3b is small and the surface potential of the image carrier 2 is constant at the predetermined voltage V₀ or constant at the ground voltage V₁, negative (−) charge directly moves from a lower voltage side to a higher voltage side, that is, the charge injection is conducted between the writing electrode 3b being in contact with the image carrier 2 and the chargeable layer 2b of the image carrier 2, as shown in FIG. 7(a). This means that charge is applied to or removed from the image carrier 2 via the charge injection. In the region where the resistance R of the writing electrode 3b is great and the surface potential of the image carrier 2 starts to vary, the application or removal of charge relative to the image carrier 2 via the charge injection is gradually reduced and discharge occurs between a conducting pattern, as will be described later, of the substrate 3a and the image carrier 2 as shown in FIG. 7(b) as the resistance R of the writing electrode 3b is increased.

The discharge between the conducting pattern of the substrate 3a and the substrate 2a of the image carrier 2 occurs when the absolute value of the voltage (the predetermined voltage V₀) between the substrate 3a and the image carrier 2 becomes higher than a discharge starting voltage Vₜₕ. The relation between the gap, between the substrate 3a and the image carrier 2, and the discharge starting voltage Vₜₕ is just as shown in FIG. 7(c), according to Paschen's law. That is, the discharge starting voltage Vₜₕ is the lowest when the gap is about 30 μm, so the discharge starting voltage Vₜₕ should be high when the gap is either larger or smaller than about 30 μm, making the occurrence of discharge difficult. Even via the discharge, charge can be applied to or removed from the surface of the image carrier 2. However, when the resistance R of the writing electrode 3b is in this region, the application or removal of charge relative to the image carrier 2 via the charge injection is greater while the application or removal of charge relative to the image carrier 2 via the discharge is smaller. This means that the application or removal of charge relative to the image carrier 2 is dominated by the application or removal of charge via the charge injection. By the application or removal of charge via the charge injection, the surface potential of the image carrier 2 becomes to the predetermined voltage V₀ to be impressed to the writing electrode 3b or the ground voltage V₁. In case of the application of charge via the charge injection, the predetermined voltage V₀ to be supplied to the writing electrode 3b is preferably set to a voltage not greater than the discharge starting voltage Vₜₕ at which the discharge occurs between the writing electrode 3b and the substrate 2a the image carrier 2.

When the resistance R of the writing electrode 3b is greater than the region, the application or removal of charge relative to the image carrier 2 via the charge injection is smaller while the application or removal of charge relative to the image carrier 2 via the discharge is greater than that via the charge injection. The application or removal of charge relative to the image carrier 2 gradually becomes dominated by the application or removal of charge via the discharge. That is, as the resistance R of the writing electrode 3b becomes greater, the application or removal of charge relative to the surface of the image carrier 2 is performed mainly via the discharge and rarely via the charge injection. By the application or removal of charge via the discharge, the surface potential of the image carrier 2 becomes to a voltage obtained by subtracting the discharge starting voltage Vₜₕ from the predetermined voltage V₀ to be impressed to the writing electrode 3b or the ground voltage V₁. It should be noted that the same is true when the predetermined voltage V₀ is of a positive (+) polarity.

Therefore, the application or removal of charge relative to the image carrier 2 via the charge injection can be achieved by satisfying a condition that the resistance R of the electrode 3b is set in such a small range as to allow the surface potential of the image carrier 2 to be constant at the predetermined voltage |V₀| (this is an absolute value because voltages of opposite (±) polarities are available) or constant at the ground voltage V₁ and by controlling the voltage to be impressed to the writing electrode 3b to be switched between the predetermined voltage V₀ and the ground voltage V₁.

FIG. 6(d) shows the relation between the capacity C of the image carrier 2 and the surface potential of the image carrier 2. The aforementioned relation when the writing electrode 3b is connected to the A side to impress the predetermined voltage V₀ of a negative (−) polarity to the writing electrode 3b is represented by a solid line in FIG. 6(d). As shown by the solid line in FIG. 6(d), the surface potential of the image carrier 2 is constant at the predetermined voltage V₀ in a region where the capacity C of the image carrier 2 is small, and the absolute value of the surface potential of the image carrier 2 decreases in a region where the capacity C of the image carrier 2 is larger than a predetermined value. On the other hand, the relation between the capacity C of the image carrier 2 and the surface potential of the image carrier 2 when the writing electrode 3b is connected to the B side to ground the writing electrode 3b is represented by a dotted line in FIG. 6(d). As shown by the dotted line in FIG. 6(d), the surface potential of the image carrier 2 is constant at substantially the constant ground voltage V₁ in a region where the capacity C of the image carrier 2 is small, and the absolute value of the surface potential of the image carrier 2 increases in a region where the capacity C of the image carrier 2 is larger than a predetermined value.

In the region where the capacity C of the image carrier 2 is small and the surface potential of the image carrier 2 is constant at the predetermined voltage V₀ or constant at the ground voltage V₁, negative (−) charge is directly transferred between the writing electrode 3b being in contact with the image carrier 2 and the chargeable layer 2b of the image carrier 2. That is, charge is applied to or removed from the image carrier 2 via the charge injection. In the region where the capacity C of the image carrier 2 is large and the surface potential of the image carrier 2 starts to vary, the application or removal of charge relative to the image carrier 2 via the charge injection is gradually reduced and discharge is started between the substrate 3a and the image carrier 2 as shown in FIG. 7(b) as the capacity C of the image carrier 2 is increased. Even via the discharge, charge can be applied to or removed from the surface of the image carrier 2. However, when the capacity C of the image carrier 2 is in this region, the application or removal of charge relative to the image carrier 2 via the charge injection is greater while the application or removal of charge relative to the image carrier 2 via the discharge is smaller. This means that the application or removal of charge relative to the image carrier 2 is dominated by the application or removal of charge via the charge injection. By the application or removal of charge via the charge injection, the surface potential of the image carrier 2 becomes to the predetermined voltage V₀ to be impressed to the writing electrode 3b or the ground voltage V₁.

When the capacity C of the image carrier 2 is greater than the region, there is now little charge injection between the writing electrode 3b and the chargeable layer 2b of the image carrier 2. This means that little or no charge is applied to or removed from the image carrier 2 via the charge injection. It should be noted that the same is true when the predetermined voltage V₀ is of a positive (+) polarity.

Therefore, the application or removal of charge relative to the image carrier 2 via the charge injection can be achieved by satisfying a condition that capacity C of the image carrier 2 is set in such a small range as to allow the surface potential of the image carrier 2 to be constant at the predetermined voltage |V₀| (this is an absolute value because voltages of opposite (±) polarities are available) or constant at the ground voltage V1 and by controlling the voltage to be impressed to the writing electrode 3b to be switched between the predetermined voltage V₀ and the ground voltage V₁.

FIG. 6(e) shows the relation between the velocity (peripheral velocity) “v” of the image carrier 2 and the surface potential of the image carrier 2. The aforementioned relation when the writing electrode 3b is connected to the A side to impress the predetermined voltage V₀ of a negative (−) polarity to the writing electrode 3b is represented by a solid line in FIG. 6(e). As shown by the solid line in FIG. 6(e), the surface potential of the image carrier 2 increases as the velocity “v” increases in a region where the velocity “v” of the image carrier 2 is relatively low, and the absolute value of the surface potential of the image carrier 2 is constant in a region where the velocity “v” of the image carrier 2 is higher than a predetermined value. The reason of increase in the surface potential of the image carrier 2 with the increase in the velocity “v” of the image carrier 2 is attributed to the fact that the charge injection to the image carrier 2 is facilitated due to friction between the writing electrode 3b and the image carrier 2. The velocity “v” of the image carrier 2 has an extent above which the facilitation of the charge injection due to friction is no longer increased and becomes substantially constant. On the other hand, the relation between the velocity “v” of the image carrier 2 and the surface potential of the image carrier 2 when the writing electrode 3b is connected to the B side to ground the writing electrode 3b is represented by a dotted line in FIG. 6(e). As shown by the dotted line in FIG. 6(e), the surface potential of the image carrier 2 is constant at the ground voltage V₁ regardless of the velocity “v” of the image carrier 2. It should be noted that the same is true when the predetermined voltage V₀ is of a positive (+) polarity.

FIG. 6(f) shows the relation between the pressing force applied to the image carrier 2 by the writing electrode 3b (hereinafter, just referred to as “the pressure of the writing electrode 3b”) and the surface potential of the image carrier 2. The aforementioned relation when the writing electrode 3b is connected to the A side to impress the predetermined voltage V₀ of a negative (−) polarity to the writing electrode 3b is represented by a solid line in FIG. 6(f). As shown by the solid line in FIG. 6(f), the surface potential of the image carrier 2 relatively rapidly increases as the pressure of the writing electrode 3b increases in a region where the pressure of the writing electrode 3b is very low, and the absolute value of the surface potential of the image carrier 2 is constant in a region where the pressure of the writing electrode 3b is higher than a predetermined value. The reason of the rapid increase in the surface potential of the image carrier 2 with the increase in the pressure of the writing electrode 3b is attributed to the fact that the contact between the writing electrode 3b and the image carrier 2 becomes further reliable by the increase in the pressure of the writing electrode 3b. The pressure of the writing electrode 3b has an extent above which the contact reliability between the writing electrode 3b and the image carrier 2 is no longer increased and becomes substantially constant. On the other hand, the relation between the pressure of the writing electrode 3b and the surface potential of the image carrier 2 when the writing electrode 3b is connected to the B side to ground the writing electrode 3b is represented by a dotted line in FIG. 6(f). As shown by the dotted line in FIG. 6(f), the surface potential of the image carrier 2 is constant at the ground voltage V₁ regardless of the pressure of the writing electrode 3b. It should be noted that the same is true when the predetermined voltage V₀ is of a positive (+) polarity.

Therefore, the application or removal of charge relative to the image carrier 2 via the charge injection can be securely and easily achieved by satisfying conditions that the resistance R of the writing electrode 3b and the capacity C of the image carrier 2 are set in such a manner as to allow the surface potential of the image carrier 2 to be constant at the predetermined voltage and that the velocity “v” of the image carrier 2 and the pressure of the writing electrode 3b are set in such a manner as to allow the surface potential of the image carrier 2 to be constant at the predetermined voltage, and by controlling the voltage to be impressed to the writing electrode 3b to be switched between the predetermined voltage V₀ and the ground voltage V₁.

Though the predetermined voltage V₀ to be impressed to the writing electrode 3b is a direct current voltage in the aforementioned embodiment, an alternating current voltage may be superimposed on a direct current voltage. When an alternating current voltage is superimposed, it is preferable that a DC component is set to be a voltage to be impressed to the image carrier 2, the amplitude of AC component is set to be twice or more as large as the discharge starting voltage Vₜₕ, and the frequency of AC component is set to be higher than the frequency in rotation of the image carrier 2 by about 500-1,000 times (for example, assuming that the diameter of the image carrier 2 is 30φ and the peripheral velocity of the image carrier 2 is 180 mm/sec, the frequency in rotation of the image carrier 2 is 2 Hz so that the frequency of AC component is 1,000-2,000 Hz.).

By superimposing an alternating current voltage on a direct current voltage as mentioned above, the application or removal of charge via discharge of the writing electrode 3b is further stabilized. In addition, the writing electrode vibrates because of the existence of the alternating current, thereby removing foreign matters adhering to the writing electrode 3b and thus preventing contamination of the writing electrode 3b.

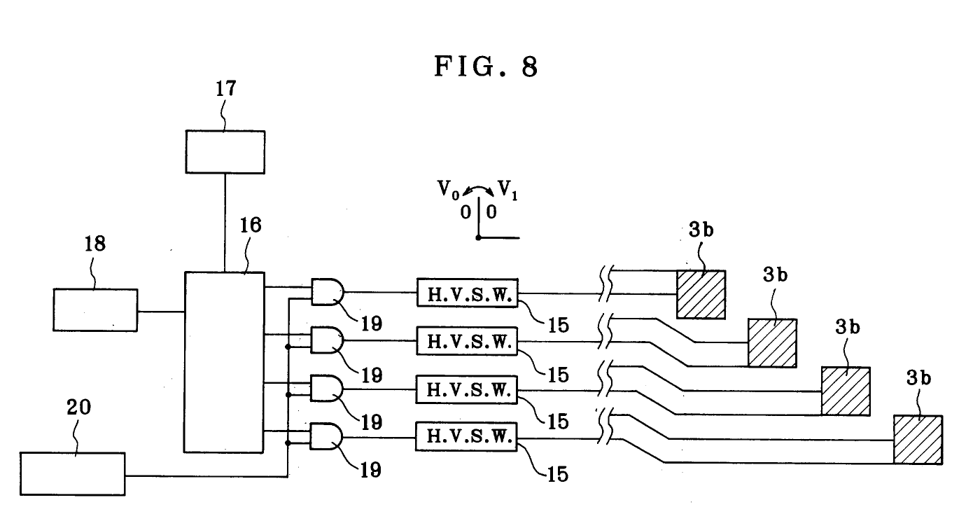

FIG. 8 is a diagram showing a switching circuit for switching the voltage to be connected to the writing electrodes 3b between the predetermined voltage V₀ and the ground voltage V₁. The writing electrodes 3b which are arranged, for example, in four lines are connected to corresponding high voltage switches (H.V.S.W.) 15, respectively. Each of the high voltage switches 15 can switch the voltage to be supplied to the corresponding electrode 3b between the predetermined voltage V₀ and the ground voltage V₁. An image writing control signal is inputted into each high voltage switch 15 from a shift resistor (S.R.) 16, to which an image signal stored in a buffer 17 and a clock signal from a clock 18 are inputted. The image writing control signal from the shift resistor is inputted into each high voltage switch 15 through each AND circuit 19 in accordance with a writing timing signal from an encoder 20. The high voltage switches 15 and the AND circuits 19 cooperate together to form the aforementioned driver 11 which controls the supply voltage for the corresponding electrodes 3b.

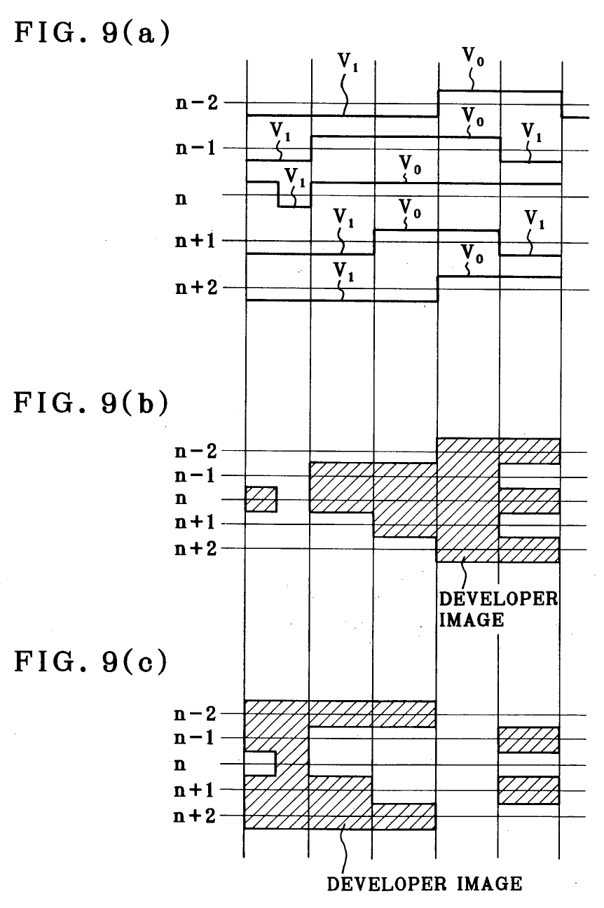

FIGS. 9(a)-9(c) show profiles when the supply voltage for each electrode 3b is selectively controlled into the predetermined voltage V₀ or the ground voltage V₁ by switching operation of the corresponding high voltage switch 15, wherein FIG. 9(a) is a diagram showing the voltage profiles of the respective electrodes, FIG. 9(b) is a diagram showing a developer image obtained by normal development with the voltage profiles shown in FIG. 9(a), and FIG. 9(c) is a diagram showing a developer image obtained by reversal development with the voltage profiles shown in FIG. 9(a).

Assuming that the electrodes 3b, for example as shown in FIGS. 9(a)-9(c), five electrodes indicated by n−2, n−1, n, n+1, and n+2, respectively, are controlled to be into the voltage profiles shown in FIG. 9(a) by switching operation of the respective high voltage switches 15. When an electrostatic latent image is written on the image carrier 2 with the electrodes 3b having the aforementioned voltage profiles and is then developed normally, the developer 8 adheres to portions at the predetermined voltage V₀ of the image carrier 2, thereby obtaining a developer image as shown by hatched portions in FIG. 9(b). When an electrostatic latent image is written in the same manner and is then developed reversely, the developer 8 adheres to portions at the ground voltage V₁ of the image carrier 2, thereby obtaining a developer image as shown by hatched portions in FIG. 9(c).

According to the image forming apparatus 1 employing the writing head 3 having the aforementioned structure, since the writing electrodes 3b are lightly pressed against and in contact with the image carrier 2 by the weak elastic restoring force of the substrate 3a so that the writing electrodes 3b can be stably in contact with the image carrier 2. Therefore, the application of charge relative to the image carrier 2 by the writing electrodes 3b can be stably conducted with high precision. This achieves more stable writing of an electrostatic latent image, thereby reliably obtaining high-quality image with high precision.

Since the writing electrodes 3b are in contact with the image carrier 2 by a small pressing force, the image carrier 2 can be prevented from being damaged by the writing electrodes 3b, thus improving the durability of the image carrier 2. Further, since the writing device 3 employs only the writing electrodes 3b without using a laser beam generating device or a LED light generating device which is large in size as conventionally used, the apparatus size can be reduced and the number of parts can also be reduced, thereby obtaining an image forming apparatus which is simple and low-price. In addition, employment of the writing electrodes 3b achieves further curbing of ozone generation.

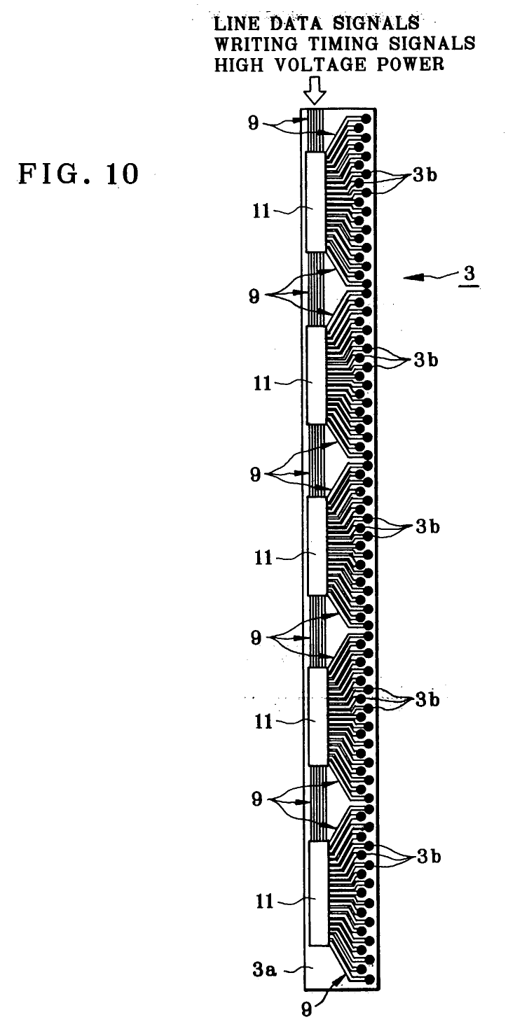

Hereinafter, the characterized features of the present invention will be described. FIG. 10 is a plan view schematically showing an embodiment of the writing head of the present invention. In the following description, like elements are identified with the same reference numerals among the drawings and the explanation of such elements will be sometimes omitted.

In FIG. 10, the respective drivers 11 are electrically connected by conductive patterns 9 made of copper foil which is formed on the substrate 3a and each line of which is formed into a thin flat bar shape having a rectangular section. In the same manner, the drivers 11 are electrically connected to the corresponding electrodes 3b by the conductive patterns 9. The conductive patterns 9 can be formed by a conventional known pattern forming method such as etching. Line data signals, writing timing signals, and high voltage power are supplied to the respective drivers 11 from the upper side in FIG. 10.

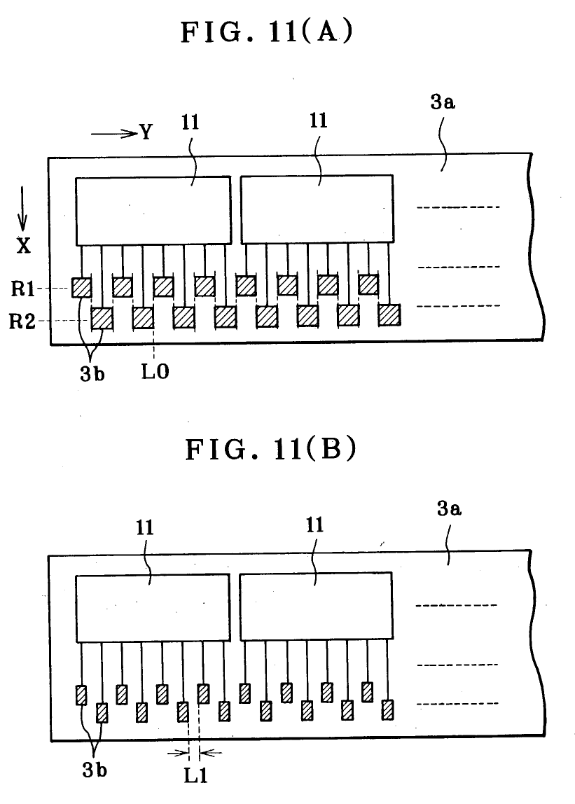

FIGS. 11(A), 11(B) are plan views showing examples of array patterns of the writing electrodes shown in FIG. 10. In FIG. 11(A), a plurality of writing electrodes are aligned in two rows R1, R2 extending in the axial direction Y of the image carrier 2 in such a manner that the writing electrodes 3b are arranged in a zigzag fashion and the electrodes are arranged such that electrodes which are in different rows but adjacent to each other are not overlapped with each other, i.e. the distance between adjacent electrodes is set to be 0 (L0) or more as seen in the circumferential direction X of the image carrier 2. Among the writing electrodes 3b, a predetermined number (eight in the illustrated example) of writing electrodes 3b are connected to and thus united as a set by a driver 11 which controls the corresponding electrodes 3b by switching the supply voltage between the predetermined voltage or the ground voltage. Plural sets of writing electrodes 3b are aligned in a row extending in the axial direction Y of the image carrier 2.

In FIG. 11(B), similarly to the above, writing electrodes 3b are arranged not to overlap to others in the circumferential direction X of the image carrier 2 and to have a distance L1 between adjacent electrodes as seen in the circumferential direction X of the image carrier 2 which is larger than that of FIG. 11(A). The upper limit of the distance L1 is such a distance that a toner image formed by developing an electrostatic latent image written by the writing electrodes appears to be filled with toner when seen with eyes.

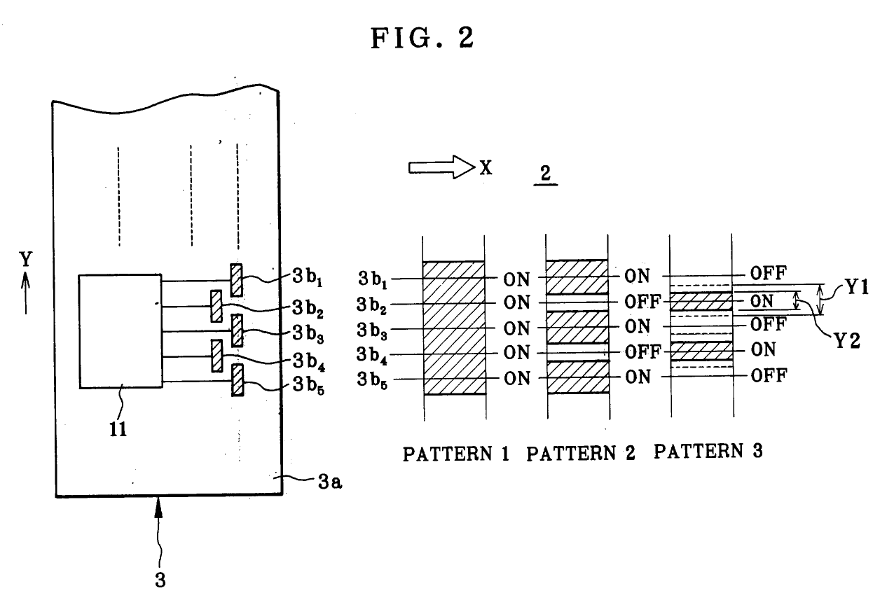

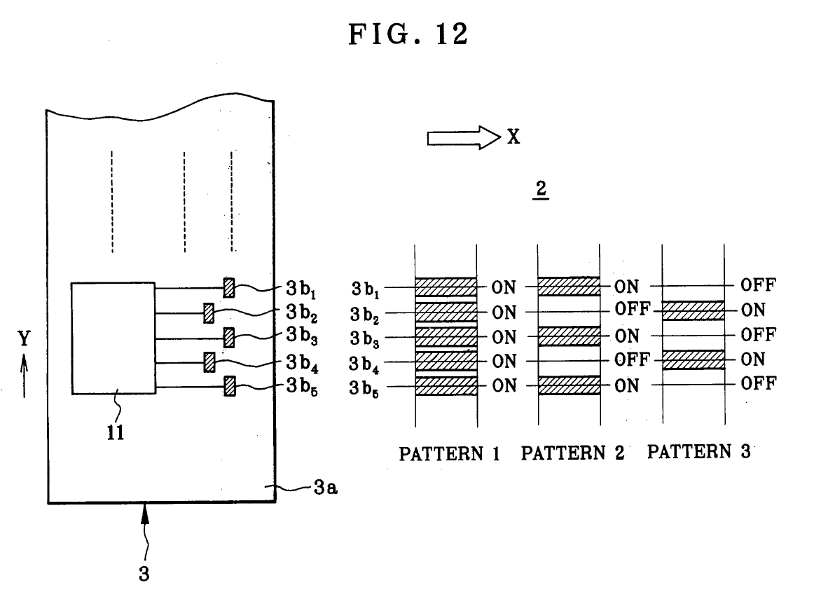

FIG. 12 is an illustration for explaining the work of the present invention. The right side of FIG. 12 shows patterns 1 through 3 of electrostatic latent images which are formed according to ON and OFF of the writing electrodes 3b1 through 3b5 by rotating the image carrier 2 in the direction X. The pattern 1 is a case that all of the writing electrodes 3b1 through 3b5 are ON so as to form electrostatic latent images corresponding to the widths in the direction Y of the writing electrodes 3b1 through 3b5. The pattern 2 is a case that the writing electrodes 3b1, 3b3, 3b5 are ON and the writing electrodes 3b2, 3b4 are OFF so as to form electrostatic latent images corresponding to the widths in the direction Y of the writing electrodes 3b1, 3b3, and 3b5. The pattern 3 is a case that the writing electrodes 3b2, 3b4 are ON and the writing electrodes 3b1, 3b3, 3b5 are OFF. Also in this case, electrostatic latent images corresponding to the widths Y2 in the direction Y of the writing electrodes 3b2, 3b4 are formed without being partially eliminated by the writing electrodes 3b1, 3b3, 3b5 located on the downstream side, thereby forming electrostatic latent images corresponding to the widths in the direction Y of the writing electrodes 3b2, 3b4. Therefore, the aforementioned arrangement can resolve the conventional problem that each electrostatic latent image is formed only with the width Y2 (FIG. 2) corresponding to the distance between the writing electrodes 3b1 and 3b3, 3b3 and 3b5.

In case that there are portions (spaces) where none of the writing electrodes 3b is in contact with the image carrier (the case of FIG. 11(B)) as shown in the pattern 1, the electric polarity at such portions may be unstable. Therefore, voltage is impressed by a charging roller 7b or a corona discharging device 7d (voltage impressing member) as shown in FIGS. 5(A)-5(D), thereby canceling the electric instability. In this manner, the impressed voltage during deployment for forming toner image is controlled optimally, thereby enabling toner to adhere to fill the gap, on the contrary, enabling toner not to adhere.

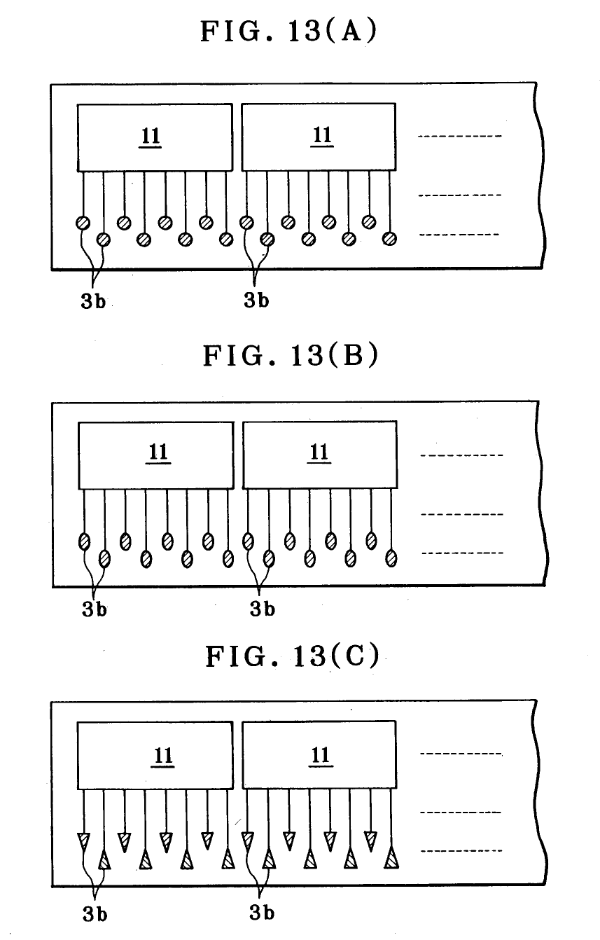

FIGS. 13(A)-13(C) are plan views schematically showing other embodiments of the writing head of the present invention. FIG. 13(A) shows an example in which each writing electrode 3b is formed in a circular shape and FIG. 13(B) shows an example in which each writing electrode 3b is formed in an elliptical shape. In the example of FIG. 13(C), each writing electrode 3b is formed in a triangle and are arranged in such a manner that the orientations of the writing electrodes 3b are alternately inverted. In either case, the plural writing electrodes 3b are arranged not to overlap with the others in the circumferential direction X of the image carrier 2. It should be noted that, instead of the aforementioned shape, each electrode 3b may be formed in any configuration that allows adjacent electrodes not to overlap with each other in the circumferential direction of the image carrier 2, for example, a trapezoid, a parallelogram, and a shape having concavity and convexity formed in sides opposed to adjacent electrodes 3b.

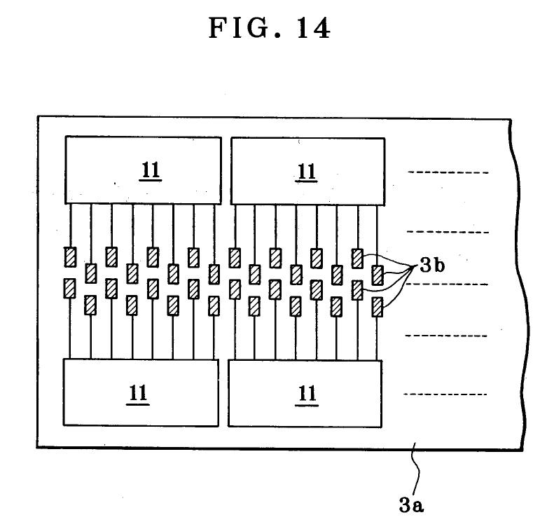

FIG. 14 is a plan view schematically showing another embodiment of the writing head of the present invention. In this embodiment, drivers 11 are arranged on both sides of a substrate 3a along the axial direction Y of the image carrier. Writing electrodes 3b corresponding to each driver 11 are aligned in two rows in such a manner that the writing electrodes 3b are arranged in a zigzag fashion. Accordingly, the writing electrodes 3b aligned in four rows in total are arranged.

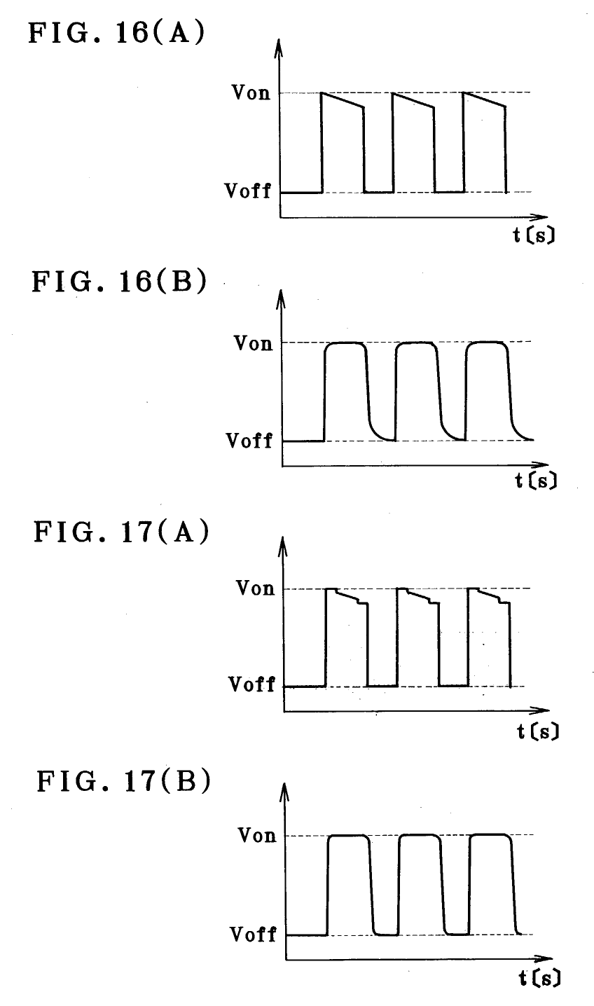

FIGS. 16(A)-21(B) show embodiments of the image forming apparatus according to the present invention, wherein each (A) is a wave form chart showing outputs to writing electrodes and each (B) is a wave form chart showing voltages at independent electrodes.

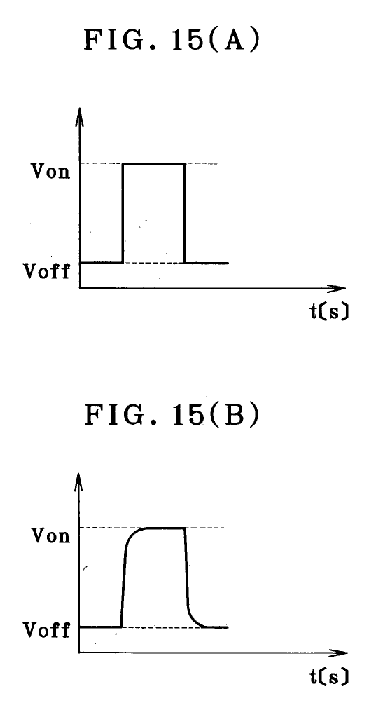

For example, when writing pulse of rectangular wave, as shown in FIG. 15(A), is applied to the writing electrode 3b into the serial CR circuit as shown in FIG. 6(b), an electrostatic latent image produced on the image carrier 2 shows delays at pulse rise portion and pulse fall portion due to the damping time constant (τ=CR) as shown in FIG. 15(B). The production instability due to the delays should be significant as the capacity C of the dielectric layer 2c of the image carrier 2 is larger or as the resistance R of the writing electrodes 3b and the independent electrodes 2d₁ (including contact resistance therebetween) is larger.

To solve this problem, in the embodiment of FIG. 16, the writing pulse to be inputted into the writing electrode 3b is controlled to have large voltage at the rise time by setting the voltage at the rise time to be higher (in case of the negative polarity, larger in the negative direction) than that of the normal value, that is, a value of applied voltage at the rise portion is set to be higher than the mean value of applied voltage as shown in FIG. 16(A). Accordingly, as shown in FIG. 16(B), the writing to the independent electrode 2d₁ with a wave nearer to the rectangular wave is achieved, thereby increasing the contrast of electrostatic latent image. Therefore, stable forming of electrostatic latent image and toner image can be achieved.

In this embodiment, the writing pulse is applied in plural stages (three stages in this embodiment), thereby improving the reproduction of electrostatic latent image and also improving the contrast of toner image. In this case, by satisfying the following relation:

|V1|>|V2|>|V3|

wherein |V₁| is the mean voltage of the writing pulse in the first stage, |V2| is the mean voltage of the writing pulse in the second stage, and |V3| is the mean voltage of the writing pulse in the third stages, further stable formation of electrostatic latent image and toner image is achieved.

In addition, by satisfying the following relation:

t1>t2>t3

wherein t1 is applying time of the writing pulse in the first stage, t2 is the applying time of the writing pulse in the second stage, and t3 is the applying time of the writing pulse in the third stage, further stable formation of electrostatic latent image and toner image is achieved.

In the embodiment of FIGS. 16(A), 16(B), the voltage is reduced linearly from the rise portion to the fall portion and then is OFF. However, in the embodiment of FIGS. 17(A), 17(B), the voltage is kept constant for a slight time period near the rise portion, after that, is reduced linearly, is kept constant for a slight time period near the fall portion, and then is OFF.

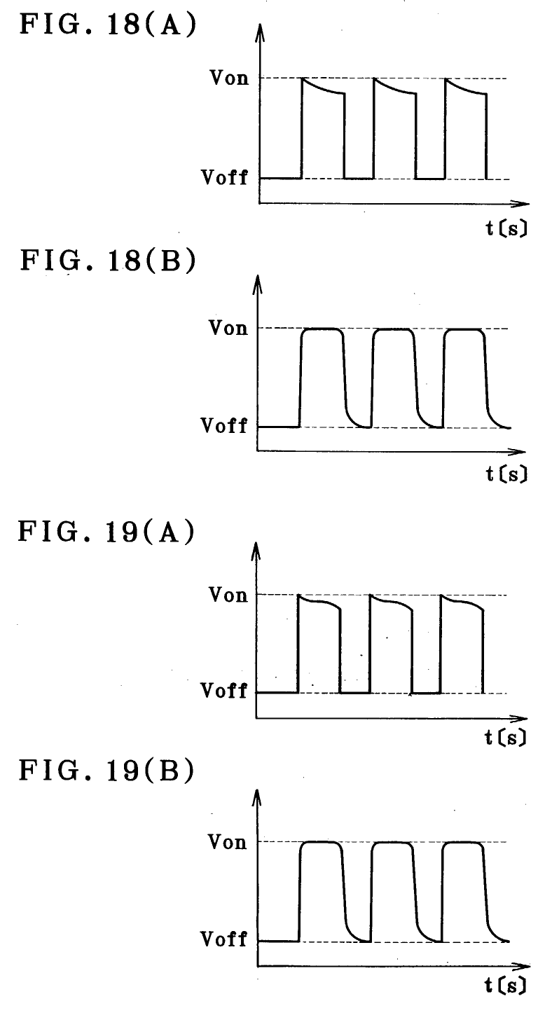

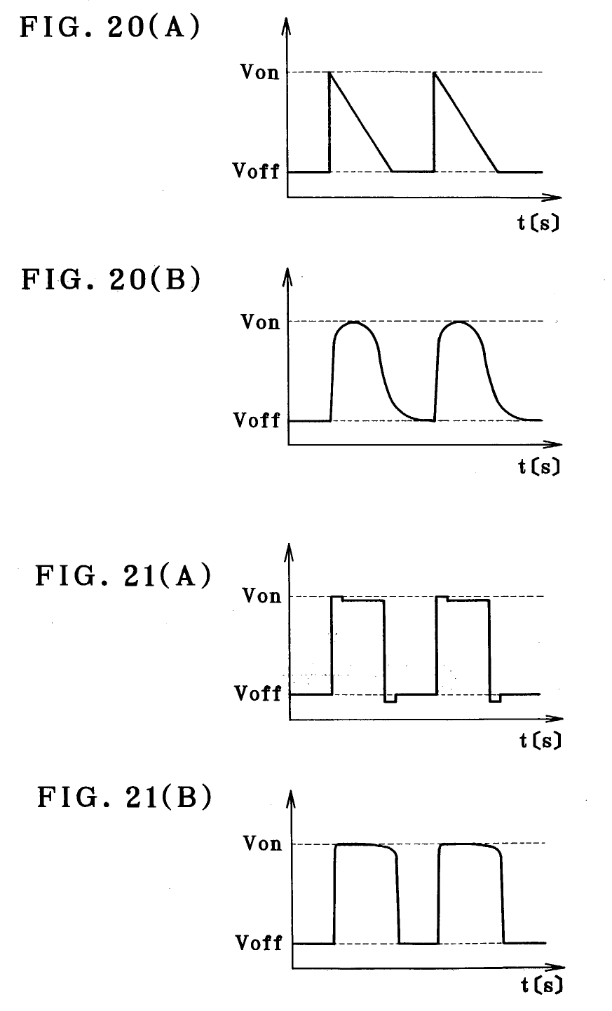

In the embodiment of FIGS. 18(A), 18(B), the voltage is reduced in a concave shape from the rise portion to the fall portion. In the embodiment of FIGS. 19(A), 19(B), the voltage is reduced in a wave-like shape from the rise portion to the fall portion. In the embodiment of FIGS. 20(A), 20(B), the voltage is reduced linearly from the rise portion to OFF. In the embodiment of FIGS. 21(A), 21(B), just after the fall, voltage is applied to have the opposite polarity for a slight time period, and then is OFF. In the embodiments of FIGS. 20(A), 20(B) and FIGS. 21(A), 21(B), the writing pulse is applied in two stages.

While the embodiments of the present invention have been described, the present invention is not limited thereto and various changes and modifications may be made. Hereinafter, specific embodiments of image forming apparatus employing the writing head of the present invention having writing electrodes 3b which are in contact with the image carrier 2 for writing an electrostatic latent image on the image carrier 2.

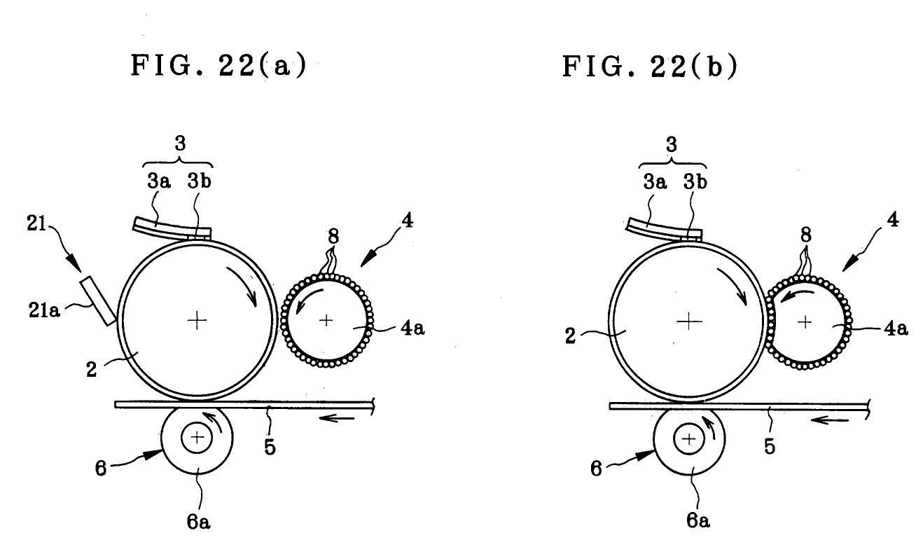

FIGS. 22(a), 22(b) are illustration schematically showing another example of the image forming apparatus using the writing head of the present invention, wherein FIG. 22 (a) is illustration showing an image forming apparatus with a cleaner, and FIG. 22(b) is an illustration showing an image forming apparatus without a cleaner, that is, it is a cleaner-less image forming apparatus.

The image forming apparatus 1 shown in FIG. 22(a) is a monochrome image forming apparatus, a substrate 3a of a writing head 3 extends from the upstream toward the downstream in the rotational direction of an image carrier 2, and writing electrodes 3b are fixed to the end of the substrate 3a. A cleaning device 21 is arranged at a downstream side than a transferring device 6 in the rotational direction of the image carrier 2. A charge control device 7 may be arranged between the writing head 3 and the cleaning device 21, but not illustrated. In case of no charge control device 7, a new latent image is substituted on the former latent image, but the number of parts and the apparatus size can be reduced because of the elimination of the charge control device 7.

In the monochrome image forming apparatus 1 having the aforementioned structure, after the surface of the image carrier 2 is made into the uniformly charged state by the charge control device 7, the writing electrodes 3b of the writing head 3 write an electrostatic latent image by applying charge to or removing charge from the surface of the image carrier 2. The latent image on the image carrier 2 is subsequently developed with developer by the development roller 4a of the developing device 4, which is spaced apart from the image carrier 2, to form a developer image. Then, the developer image on the image carrier 2 is transferred to a receiving medium 5 by the transferring device 6. Residual developer on the image carrier 2 after the transfer is removed by a cleaning blade 21a of the cleaning device 21 and cleaned surface of the image carrier 2 is uniformly charged by the charge control device 7 again. The image forming apparatus 1 of this example can be manufactured to have a smaller size and simple structure because it employs the writing head 3 of the present invention.

The image forming apparatus 1 shown in FIG. 22(b) is similar to the image forming apparatus 1 shown in FIG. 22(a), but without the cleaning device 21, that is, it is a cleaner-less image forming apparatus. In the image forming apparatus 1 of this example, the development roller 4a of the developing device 4 is in contact with the image carrier 2 so as to conduct contact development.

In the image forming apparatus 1 having the aforementioned structure, the surface of the image carrier 2 is made into the uniformly charged state by the charge control device 7, not shown, together with residual developer on the image carrier after the former transfer. Then, the writing electrodes 3b of the writing head 3 write an electrostatic latent image on the surface of the image carrier 2 and on the residual developer by applying charge to or removing charge from the surface of the image carrier 2 and the surface of the residual developer. By the developing device 4, the latent image is developed. During this, by selectively charging the writing electrodes 3b to have the same polarity as the original polarity of the developer 8, residual developer on non-image portions of the image carrier 2 is charged into the polarity by the writing electrodes 3b so as to move toward the developing device 4, while residual developer on image portions of the image carrier 2 still remains on the image carrier 2 as developer for subsequent developing. By transferring the residual developer on the non-image portions toward the developing device 4 as mentioned above, the surface of the image carrier 2 can be cleaned even without the cleaning device 21. In particular, a brush may be arranged at a downstream side than the transferring device 6 in the rotational direction of the image carrier 2, but not illustrated. In this case, the residual developer can be scattered to be uniformly distributed on the image carrier 2 by this brush, thus further effectively transferring the residual developer on the non-image portions to the developing device 4.

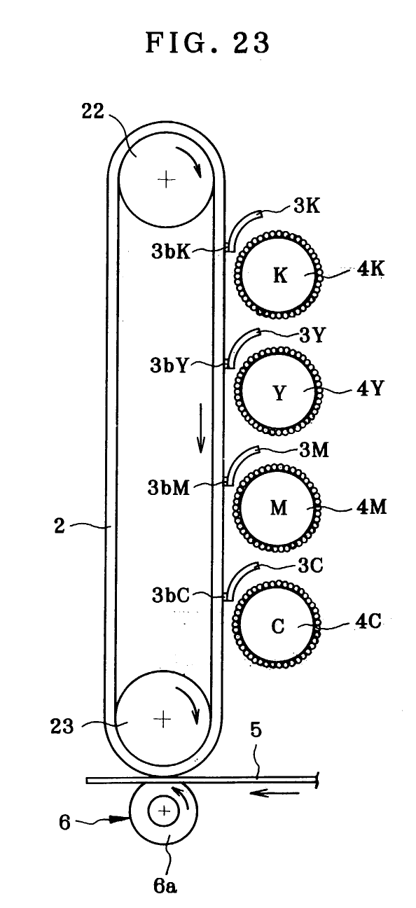

FIG. 23 is an illustration schematically showing another example of the image forming apparatus employing the writing head according to the present invention. The image forming apparatus 1 of this example is an image forming apparatus for developing full color image by superposing developer images in four colors of black K, yellow Y, magenta M, and cyan C on an image carrier 2 where in the image carrier 2 is in an endless belt-like form. This endless belt-like image carrier 2 is tightly held by two rollers 22, 23 and is rotatable in the clockwise direction in FIG. 23 by a driving roller, i.e. one of the rollers 22, 23.

Writing heads 3_{K}, 3_{Y}, 3_{M}, 3_{C} and developing devices 4_{K}, 4_{Y}, 4_{M}, 4_{C} for the respective colors are arranged along a straight portion of the endless belt of the image carrier 2, in the order of colors K, Y, M, C from the upstream of the rotational direction of the image carrier 2. It should be understood that the developing devices 4_{K}, 4_{Y}, 4_{M}, 4_{C} may be arranged in any order other than the illustrated one. All of the respective writing electrodes 3b_{K}, 3b_{Y}, 3b_{M}, 3b_{C} of the writing heads 3_{K}, 3_{Y}, 3_{M}, 3_{C} are formed on flexible substrates 3a_{K}, 3a_{Y}, 3a_{M}, 3a_{C} as mentioned above. Also in the image forming apparatus of this example, a charge control device as mentioned above is disposed adjacent to a straight portion of the endless belt of the image carrier 2, at a side opposite to the side where the writing heads 3_{K}, 3_{Y}, 3_{M}, 3_{C} are arranged, but not illustrated.

In the image forming apparatus 1 of this example having the aforementioned structure, first an electrostatic latent image for black K is written on the surface of the image carrier 2 by electrodes 3b_{K} of the writing head 3_{K} for black K. The electrostatic latent image for black K is then developed by the developing device 4_{K} so as to form a black developer image on the surface of the image carrier 2. An electrostatic latent image for yellow Y is subsequently written on the surface of the image carrier 2 and on the black developer image, already formed, by the electrodes 3b_{Y} of the writing head 3_{Y} for yellow Y such that the electrostatic latent image for yellow Y is superposed on the black developer image. The electrostatic latent image for yellow Y is then developed by the developing device 4_{Y} so as to form a yellow developer image on the surface of the image carrier 2. In the same manner, an electrostatic latent image for magenta M is subsequently written on the surface of the image carrier 2 and on the black and yellow developer images, already formed, by the electrodes 3b_{M} of the writing head 3_{M} for magenta M such that the electrostatic latent image for magenta M is superposed on the black and yellow developer images. The electrostatic latent image for magenta M is then developed by the developing device 4_{M} so as to form a magenta developer image on the black and yellow developer images and the surface of the image carrier 2. Moreover, an electrostatic latent image for cyan C is subsequently written on the surface of the image carrier 2 and on the black, yellow and magenta developer images, already formed, by the electrodes 3b_{C} of the writing head 3_{C} for cyan C such that the electrostatic latent image for cyan C is superposed on the black, yellow and magenta developer images. The electrostatic latent image for cyan C is then developed by the developing device 4_{C} so as to form a cyan developer image on the black, yellow and magenta developer images and the surface of the image carrier 2. These developer images are toned. Then, these developer images are transferred to the receiving medium 5 by the transferring device 6 to form a multicolored developer image on the receiving medium 5. It should be understood that the developer of colors may be deposited in any order other than the aforementioned order.

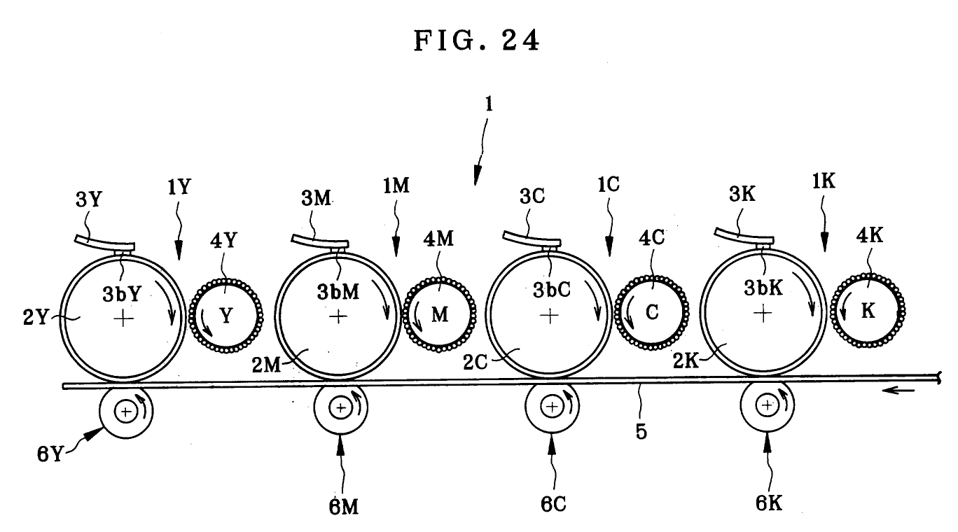

FIG. 24 is a view schematically showing still another example of the image forming apparatus employing the writing head according to the present invention. The image forming apparatus 1 of this example comprises image forming units 1_{K}, 1_{C}, 1_{M}, 1_{Y} for the respective colors which are arranged in tandem in this order from the upstream in the feeding direction of a receiving medium 5. It should be understood that the image forming units 1_{K}, 1_{C}, 1_{M}, 1_{Y} may be arranged in any order. The image forming units 1_{K}, 1_{C}, ₁_{M}, 1_{Y} comprise image carriers 2_{K}, 2_{C}, 2_{M}, 2_{Y}, writing heads 3_{K}, 3_{C}, 3_{M}, 3_{Y}, developing devices 4_{K}, 4_{C}, 4_{M}, 4_{Y}, and transferring devices 6_{K}, 6_{C}, 6_{M}, 6_{Y}, respectively. In the image forming units 1_{K}, 1_{C}, 1_{M}, 1_{Y} of this example, charge control devices 7, not shown, as mentioned above may be disposed on the upstream sides of the writing heads 3_{K}, 3_{C}, 3_{M}, 3_{Y} in the rotational direction of the image carriers 2_{K}, 2_{C}, 2_{M}, 2_{Y}, respectively.

The actions of the image forming apparatus 1 of this example having the aforementioned structure will now be described. First in the image forming unit 1_{K} for black K, after the surface of the image carrier 2_{K} is uniformly charged by the charge control device 7 for black K, an electrostatic latent image for black K is written on the surface of the image carrier 2_{K} by the electrodes 3b_{K} of the writing head 3_{K}. The electrostatic latent image for black K is then developed by the developing device 4_{K} so as to form a black developer image on the surface of the image carrier 2_{K}. The black developer image on the image carrier 2_{K} is transferred to the supplied receiving medium 5 by the transferring device 6_{K} so as to form a black developer image on the receiving medium 5. Subsequently, in the image forming unit 1_{C} for cyan C, after the surface of the image carrier 2_{C} is uniformly charged by the charge control device 7 for cyan C, an electrostatic latent image for cyan C is written on the surface of the image carrier 2_{C} by the electrodes 3b_{C} of the writing head 3_{C}. The electrostatic latent image for cyan C is then developed by the developing device 4_{C} so as to form a cyan developer image on the surface of the image carrier 2_{C}. The cyan developer image on the image carrier 2_{C} is transferred to the receiving medium 5 by the transferring device 6_{C}, supplied and already having the black developer image thereon, such that the cyan developer image is formed to be superposed on the black developer image on the receiving medium 5. In the same manner, in the image forming unit 1_{M} for magenta M, an electrostatic latent image for magenta M is written on the surface of the image carrier 2_{M} by the electrodes 3b_{M} of the writing head 3_{M} and then developed by the developing device 4_{M} to form a magenta developer image, and the magenta developer image is transferred to the receiving medium 5 by the transferring device 6_{M} such that the magenta developer image is formed and superposed on the developer images already formed on the receiving medium 5. After that, in the image forming unit 1_{Y} for yellow Y, an electrostatic latent image for yellow Y is written on the surface of the image carrier 2_{Y} by the electrodes 3b_{Y} of the writing head 3_{Y} and then developed by the developing device 4_{Y} to form a yellow developer image on the image carrier 2Y, and the yellow developer image is transferred to the receiving medium 5 by the transferring device 6_{Y}, thereby superposing the developer images for the respective colors to produce a toned multicolored developer image on the receiving medium 5.

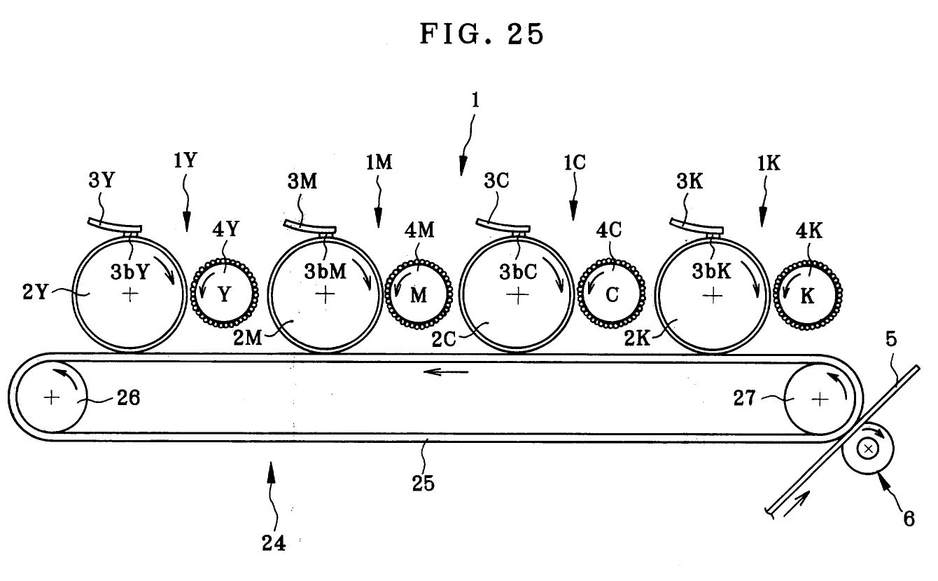

FIG. 25 is a view schematically showing further another example of the image forming apparatus employing the writing head according to the present invention. In the image forming apparatus 1 of this example, the respective color developer images formed on the image carriers 2_{K}, 2_{C}, 2_{M}, 2_{Y} are temporally transferred to another medium before transferred to the receiving medium 5. That is, the image forming apparatus 1 has an intermediate transferring device 24. The intermediate transferring device 24 comprises an intermediate transferring member 25 taking the form as an endless belt. This intermediate transferring member 25 is tightly held by two rollers 26, 27 and is rotated in the counter-clockwise direction in FIG. 25 by the drive of one of the rollers 26, 27. Image forming units 1_{K}, 1_{C}, 1_{M}, 1_{Y} are arranged along a straight portion of the intermediate transferring member 25. Further, the image forming apparatus 1 has a transferring device 6 disposed adjacent to the roller 27.

In the image forming apparatus 1 of this example having the aforementioned structure, developer images for the respective colors are formed on the image carriers 2_{K}, 2_{C}, 2_{M}, 2_{Y}, and the developer images for the respective colors are transferred to the intermediate transferring member 25 to be superposed and toned on each other. The developer images for the respective colors temporally transferred to the intermediate transferring member 25 are transferred to the receiving medium 5 by the transferring device 6 so as to form a multicolor developer image on the receiving medium 5.

Accordingly, employment of the writing heads 3 of the present invention still achieves reduction in size and simplification of the structure of such a color image forming apparatus comprising an intermediate transferring device 24 and image forming unit 1_{K}, 1_{C}, 1_{M}, 1_{Y} for the respective colors arranged in tandem.

What is claimed is:

1. A writing head having a plurality of writing electrodes which are arranged along the axial direction of an image carrier such that the writing electrodes are in contact with the image carrier, wherein the writing electrodes are aligned in the axial direction and the circumferential direction of the image carrier such that the writing electrodes which are most adjacent to each other in the axial direction are not overlapped with each other as seen in the circumferential direction of the image carrier.

2. A writing head as claimed in claim 1, wherein said writing electrodes are arranged in a zigzag fashion.

3. A writing head as claimed in claim 1, wherein when there is a space between said writing electrodes which are most adjacent to each other when seem in the circumferential direction of the image carrier, voltage is applied to each space by a voltage applying member.

4. An image forming apparatus comprising at least: an image carrier on which an electrostatic latent image is formed, a writing head for writing said electrostatic latent image on said image carrier, and a developing device for developing said electrostatic latent image on said image carrier, wherein said electrostatic latent image, written on said image carrier by said writing head, is developed by said developing device, thereby forming an image, said image forming apparatus being characterized in that said writing head has a plurality of writing electrodes which are arranged along the axial direction of the image carrier such that the writing electrodes are in contact with the image carrier, wherein the writing electrodes are aligned in the axial direction and the circumferential direction of the image carrier such that the writing electrodes which are most adjacent to each other in the axial direction are not overlapped with each other as seen in the circumferential direction of the image carrier.

5. An image forming apparatus as claimed in claim 4, wherein said writing heads and said developing devices are provided for respective colors of black, yellow, magenta, and cyan so that developer images of the respective colors are formed and superposed on said image carrier by said writing heads and said developing devices for the respective colors.

6. An image forming apparatus as claimed in claim 4, wherein said image carriers, said writing heads, and said developing devices are provided for respective colors of black, yellow, magenta, and cyan so as to compose image forming units for the respective colors which are arranged in tandem.

7. An image forming apparatus as claimed in claim 6, further comprising an intermediate transfer device to which developer images of the respective colors formed by said image forming units for the respective colors are temporally transferred.

8. An image forming apparatus comprising at least: an image carrier having a chargeable layer, a writing head having a plurality of writing electrodes arranged in the axial direction of said image carrier, and a developing device for developing an electrostatic latent image written by said writing electrodes, wherein the writing pulse to be applied to said writing electrodes is controlled such that a value of applied voltage at the rise portion is set to be higher than the mean value of applied voltage.

9. An image forming apparatus as claimed in claim 8, wherein said writing pulse is applied in plural stages.

10. An image forming apparatus as claimed in claim 9, wherein the absolute value of the applied voltage of the writing pulse in the latter stage is set to be smaller than the absolute value of the applied voltage in the former stage.

11. An image forming apparatus as claimed in claim 9, wherein the applying time period of the writing pulse in the latter stage is set to be shorter than the applying time period of the writing pulse in the former stage.

12. An image forming apparatus as claimed in claim 8, wherein said writing heads and said developing devices are provided for respective colors of black, yellow, magenta, and cyan so that developer images of the respective colors are formed and superposed on said image carrier by said writing heads and said developing devices for the respective colors.

13. An image forming apparatus as claimed in claim 8, wherein said image carriers, said writing heads, and said developing devices are provided for respective colors of black, yellow, magenta, and cyan so as to compose image forming units for the respective colors which are arranged in tandem.

14. An image forming apparatus as claimed in claim 13, further comprising an intermediate transfer device to which developer images of the respective colors formed by said image forming units for the respective colors are temporally transferred.
